(19) United States
(12) Patent Application Publication
(10) Pub. No.: US 2010/0004877 A1
(43) Pub. Date: Jan. 7, 2010

(54) DEVICE FOR THE SIMULATION OF THE AGING OF POLYMERIC MATERIALS

(75) Inventors: Antonio Marin Trujillo, Leganes (Madrid) (ES); Jose Fagoaga Lopez, Las Rozas (Madrid) (ES); Fernando Rull Perez, Laguna De Duero (Valladolid) (ES)

Correspondence Address: DARBY & DARBY P.C., P.O. BOX 770, Church Street Station, New York, NY, 10008-0770, US

(73) Assignee: REPSOL QUIMICA, S.A., Madrid (ES)

(21) Appl. No.: 12/167,328

(22) Filed: Jul. 3, 2008

(51) Int. Cl. G01L 1/00; G01K 11/30

(52) U.S. Cl. 702/42; 702/134

(57) ABSTRACT

The present invention relates to a device that simulates the conditions causing the aging of polymeric material used in agricultural environments in order to obtain information about the rate of degradation of the material. For this purpose, the device of the invention exposes a test specimen of polymeric material to radiation, temperature, mechanical stress, humidity, etc. conditions and checks the effect produced in the material.

### FIELD OF THE INVENTION

The main object of the present invention is a device that simulates the conditions causing the aging of the polymeric materials used in agricultural environments in order to obtain information about their rate of degradation.

### BACKGROUND

The use of plastics for greenhouses enables crops to be grown under cover at seasons of the year unfavourable for their cultivation in the field, with a better control of production, which results in an improved yield, an enhancement of the quality and, consequently, the possibility of increasing the price of the product.

The films used in the covers of the greenhouses are damaged by the action of the solar radiation received and stresses provoked by winds, as well as by hail, changes in temperature, their actual weight and the anchorages of their support frame. The use of chemical products (pesticides and fertilizers) accelerates the breakdown of these films. It is therefore necessary to use materials that are resistant both to the aggressions of physical and mechanical agents and of chemical substances and with proven stability. In addition, it is important to be able to predict their performance over time, with prior knowledge how the different degradation mechanisms will affect the optical and mechanical properties of the plastic. This information is used subsequently to select new materials or upgrade existing ones.

There has been no system or procedure to date, however, that enables us to predict the performance of a particular material when subjected to the above-mentioned stresses.

### DESCRIPTION OF THE INVENTION

The present invention describes a device that sets out to simulate in the most realistic way possible the environmental and operating conditions that have to be withstood by polymeric materials used in greenhouses or similar constructions. With this purpose in mind, the device is provided with a set of monitoring, measuring and security elements (sensors, actuators, electronic control instrumentation and measuring and control software) that will be specified in detail in the present description.

The degradation undergone by the polymeric materials, usually plastics, used for the construction of greenhouses or similar structures is brought about by solar radiation (photodegradation), primarily by the ultra-violet range of the spectrum and by the mechanical stress to which the materials are subjected. These processes are especially affected by the greenhouse interior temperature, which reaches values of up to 60° C.-70° C. at the support rods making up the structural frame. Chemical aggression and humidity are also major factors.

Thus, an initial aspect of the invention describes a device for the simulation of the aging of polymeric materials, which comprises a chamber where a test specimen of polymeric material is disposed, which comprises:
1) Radiation means that apply radiation to the test specimen of polymeric material.

Despite the fact that the ultra-violet spectrum represents only 5% of sunlight, it is responsible for the bulk of the photochemical degradation brought about in materials. In order to simulate the degradation caused by sunlight, it is not necessary to reproduce its whole spectrum, but only one specific region, as the radiation emitted on shorter wave lengths, though being more energetic, causes degradation of material in a shorter time than solar radiation. This enables the damage caused in the course of months or years of outdoor exposure to be reproduced in a few days or weeks, so that the performance of a given type of polymeric material subject to external aggressions over a much longer period of time, a year for example, may be predicted in a short trial, lasting one week for instance. The most suitable solar radiation spectrum, therefore, for the present invention is comprised between 10 nm to 800 nm wavelength, which is usually subdivided into four sub-bands: UV-C (10-290 nm), UV-B (290-315 nm), UV-A (315-400 nm) and Visible (400-800 nm).

Therefore, in accordance with a preferred embodiment of the invention, the means of radiation are ultra-violet lamps with a maximum emission in the UV-A, UV-B or Visible band and, in addition, their irradiance is up to 0.8 W/m².
2) Means of heating, which raise the temperature of the interior of the chamber.

To simulate the temperatures that are reached in greenhouses, it is necessary to heat the air in the interior of the chamber evenly. Any means may be used for this purpose that permit controlled heating of the chamber, although in a preferred embodiment of the invention a blower fitted with resistors is used, which warms the air and blows it into the chamber. In yet another preferred embodiment, an additional resistor provided in the chamber is used, which may be adjustable or else controlled by a thermostat. In accordance with another preferred embodiment of the invention, a fan is used for establishing a uniform temperature throughout the chamber so that there are no areas warmer than others.
3) Means of application of stress, which apply mechanical stress on the test specimen of polymeric material.

As is well known, the polymeric material that forms the greenhouses or similar structures is subjected to mechanical stresses that also affect the aging process. In addition, the mechanical stress borne by a piece of polymeric material that forms a greenhouse depends on the area where it is situated, on the structural form of the greenhouse, etc. In order to simulate these mechanical stresses, the system of the invention comprises means of application of stress which may be any device capable of applying an adjustable stress to the test specimens of polymeric material whose aging is to be simulated.

In a preferred embodiment, the means of application of stress comprise a set of weights fixed to an end of this test specimen of polymeric material, while the opposite end of the test specimen is fastened to a fixed point. In this way, the stress to which the test specimen is subjected is controlled by modifying the number of weights fixed to its end.
4) Means of data acquisition, which collect data on the external actions to which the test specimen of polymeric material is subjected.

These measures are basically necessary for controlling radiation, temperature and the mechanical stress to which the test specimen is subjected. In preferred embodiments of the invention, the data acquisition means comprise at least temperature sensors, radiation sensors and stress sensors.

The radiation sensors may be situated anywhere, in principle, providing that the radiation received by the test specimen of polymeric material may be calculated from the data obtained. Preferably, however, the radiation sensors are disposed at the same distance from the means of radiation, perpendicularly to the test specimen of polymeric material, i.e. so that a particular radiation sensor receives the same radiation as at least one section of the corresponding test specimen of polymeric material. This enables one to obtain a reliable and representative measurement of the luminous intensity received by the test specimens at any time. Preferably, the radiation sensors are photodiodes.

Furthermore, at least one temperature sensor is provided to measure the temperature inside the chamber. The temperature sensors are preferably Pt100 type sensors.

As regards mechanical stress, at least one stress sensor is used to ascertain the stress to which the test specimen is subjected. This sensor may not be necessary, for instance, in the event of the means of application of stress being a set of weights, which enables the stress to be deduced immediately. However, it could be necessary with other types of stress application means, such as for instance a rotary rod around which one of the ends of the test specimen is winded up, while the opposite end of the specimen is fixed.
5) A means of processing connected to the above means, which controls the operation of the means of radiation, heating and application of stress in accordance with the information received on the means of data acquisition.

In preferred embodiments of the invention, the means of processing may be a PC, a microprocessor, a microcontroller, a FPGA, a DSP, an ASIC, etc.

Thus, the system of the invention simulates the action of solar radiation, temperature and mechanical stress to which a piece of polymeric material forming part of a greenhouse with a given construction is subjected. However, it has been discovered that the areas of the pieces (or films) of polymeric material that age more quickly are those located adjacent to the posts, normally metal tubes, which form the support of the greenhouse frame. For this reason, the device of the invention also preferably comprises an additional piece that is in direct contact with the test specimen of polymeric material, more preferably taking the form of a round section rod.

The incident radiation on the additional piece brings about an increase in its temperature, such that it is normally warmer than the air surrounding it, thereby simulating the performance of the greenhouse frame posts. In yet another preferred embodiment, the material of which the additional piece is made of is selected from iron, wood, steel, galvanized steel, aluminium, etc.

In addition, conditions of high humidity may arise in the interior of a greenhouse of similar structure. In order to simulate these conditions, another preferred embodiment of the device in accordance with the present invention also comprises means of application of humidity. These means may be of any type enabling the level of humidity inside the chamber to be controlled. In addition, the device also preferably comprises a humidity sensor, such that the means of processing, connected to both, may control the operation of the means of application of humidity on the basis of the information received from the humidity sensor.

Polymeric material forming a greenhouse or similar structure is often also subjected to chemical aggression, mainly due to agrochemicals such as fertilizers and pesticides, among others, employed in agriculture. In order to simulate their effect in the degradation of the polymeric material, chemical aggression means, such as an automatic atomizer, are included inside the chamber. In addition, suitable detection means can be added for analyzing the composition of the air contained in the chamber. This way, the quantity of the chemically aggressive substance introduced in the chamber may be controlled in such a way that its concentration is kept inside a predetermined range.

Finally, it may be necessary to detect the breakage of the test specimen of polymeric material whose performance is being analysed. For this purpose, means of detecting breakage are preferably used, which are connected to the processing means. Thus, the processing means save the time of breakage of the specimen and the conditions to which it has been subjected during the simulation. In preferred embodiments of the invention, the means of detection of breakage comprise microswitches.

A second aspect of the invention describes a procedure for the simulation of the aging of polymeric materials, which comprises the following operations:
1) Subjecting a test specimen of polymeric material disposed in the interior of a chamber at the same time at a temperature of between 20°-75° C., at an ultraviolet radiation of between 290 nm and 800 nm, with an irradiance of between 0.0-0.8 W/m² and a mechanical stress below the creep limit of polymeric material. The irradiance of the ultraviolet radiation applied may be above the solar radiation solar so as to thereby achieve an effect of accelerated aging of the polymeric material.

To attain an even more realistic simulation of the conditions to which a greenhouse is subjected, in preferred embodiments of the invention, this operation is carried out following alternate cycles of illumination and darkness, where the temperature in the illumination cycle is in the range 20° C.-75° C. and the radiation is between 290 nm and 800 nm and the irradiance between 0.4-0.8 W/m², while in the darkness cycle the temperature is between 20° C.-75° C. and in absence of ultraviolet radiation. Preferably, the duration of the illumination cycles is 6-10 times longer than the duration of the darkness cycles.
2) Checking the effect of the above operations on the aging of the test specimen of polymeric material.

A preferred embodiment of the procedure of the invention further comprises the operation of detecting the moment when breakage takes place in the test specimen of polymeric material.

Finally, in a further preferred embodiment the polymeric material test specimen is subjected to an external chemical aggression before its introduction in the chamber. This way, the effect of chemical aggression due to agrochemicals such as fertilisers and pesticides, among others, used in agriculture is also simulated.

### BRIEF DESCRIPTION OF THE DRAWINGS

To supplement the description that is being given and in order to assist in a clearer understanding of the features of the invention, in accordance with a preferred practical embodiment of same, a set of drawings is attached as an integral part of said description, wherein there is represented on an informative and non-restrictive basis the following:

FIG. 1.—It shows a partially open front view of an example of the device in accordance with the present invention.

FIG. 2.—It shows an open lateral view of the specimen embodiment of the device of FIG. 1.

FIG. 3.—It shows a graph that represents the irradiance versus the wavelength of the light transmitted by UV-A lamps in accordance with one embodiment of the invention.

FIG. 4.—It shows a graph that represents the irradiance versus the wavelength of the light transmitted by UV-B lamps in accordance with another embodiment of the invention.

### EXAMPLE

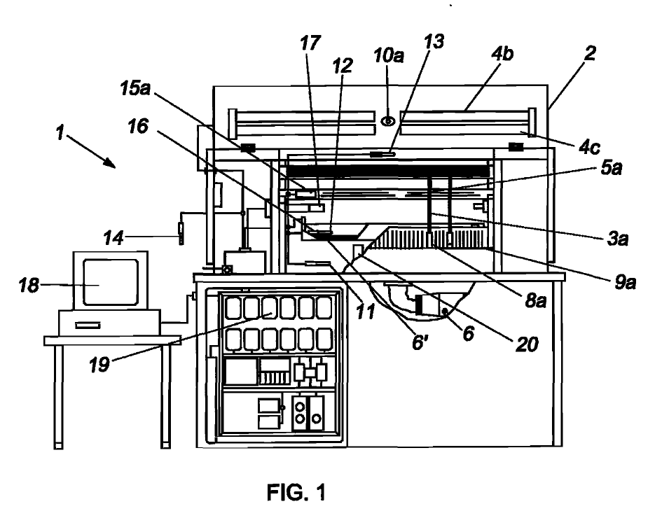

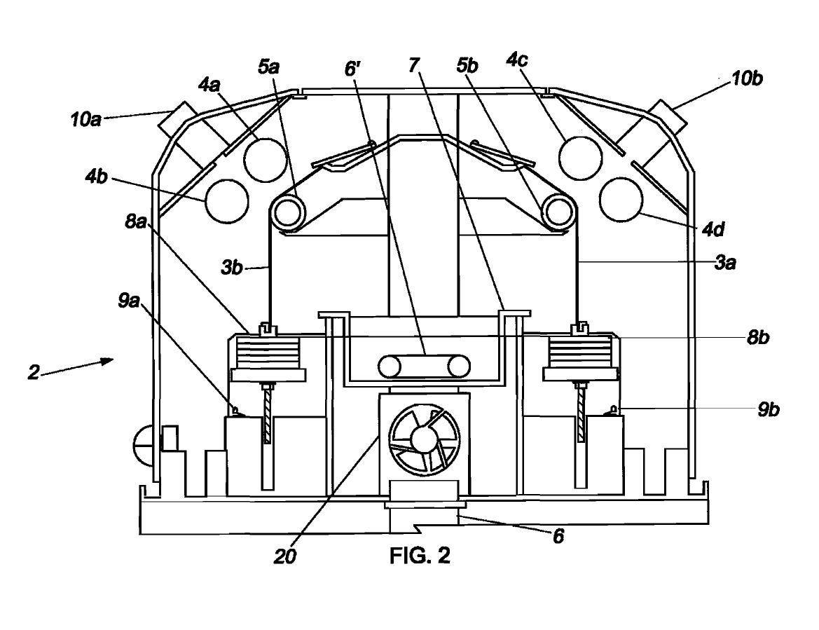

A particular example of the present invention [[it]] is described below with reference to the figures. FIGS. 1 and 2 show an embodiment of the device (1) for the simulation of the aging of polymeric materials, which comprises a chamber (2) that presents a rectangular structure symmetrical in respect of its longitudinal axis. In this example we analyse at the same time two test specimens (3a, 3b) of polymeric material, which are arranged in the chamber (2), while a lower cabinet houses the control electronics, the power supply, various items of hydraulic equipment, etc. In this example, the polymeric material of which the test specimens (3a, 3b) are made is plastic.

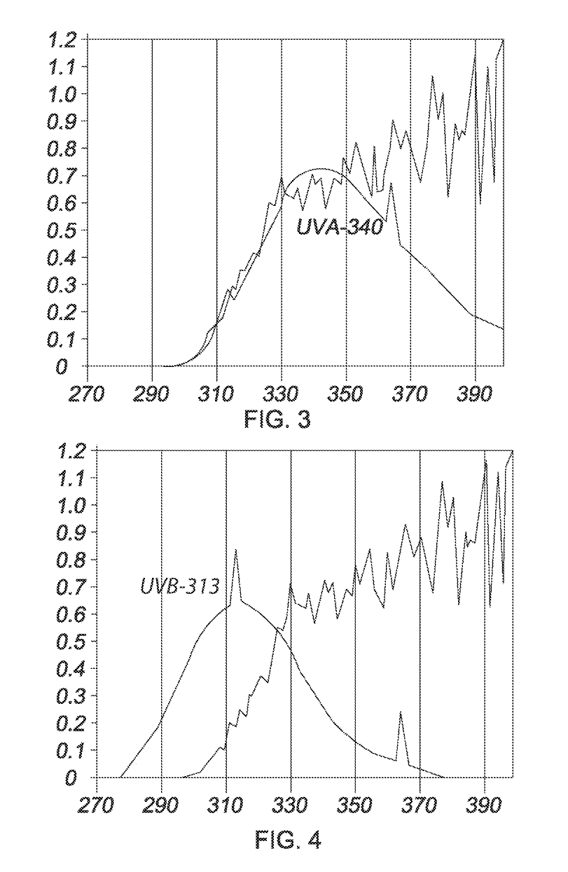

The means of radiation (4a, 4b, 4c, 4d) are four UV lamps arranged in two pairs, each one situated at one of the two sides of the chamber (2), such that the radiation emitted strikes perpendicularly the plastic test specimens (3a, 3b) whose performance we want to study. Different types of means of radiation (4a, 4b, 4c, 4d) may be used on each side, though specifically in this example their emission maximums are, respectively, at 340 nm, in the UV-A region of the spectrum (FIG. 3) on the right-hand side, and at 313 nm, in the UV-B region of the spectrum (FIG. 4) on the left-hand side. The solar radiation spectrum may also be seen in FIGS. 3 and 4. The luminous flux of the means of radiation (4a, 4b, 4c, 4d) is controllable between 0.0-0.8 W/m² using known means.

Test specimens (3a, 3b) are arranged so that three differentiated portions are formed, each of which is subjected to conditions that simulate the conditions of specific parts of a greenhouse or the like. The first area, or area A, of the plastic test specimens (3a, 3b) receives UV directly from the means of radiation (4a, 4b, 4c, 4d), and therefore simulates the area of the greenhouses exposed directly to solar radiation. Besides receiving radiation too, area B of the test specimens (3a, 3b) is in contact with pieces (5a, 5b), which are round section metal rods in this case and are, therefore, subject to more radical changes in temperature. In addition, the type of material of the pieces (5a, 5b) also affects the aging of the plastic test specimens (3a, 3b). Finally, area C of the test specimens (3a, 3b) does not receive direct illumination, so it represents the plastic situated in the less illuminated areas of the greenhouse, such as the north face and the east and west sides. In the present example, the test specimens (3a, 3b) are 20 cm long and 1 cm wide.

The means of heating (6, 6′) the embodiment of the example comprise a blower (6) and a water resistor (6′). The blower (6) may supply either hot or cold air, as it includes two electrical resistors (not shown). Furthermore, the water resistor (6′) is disposed inside a tray (7), which is placed in the middle of the chamber (2) and may contain sand, gravel, or other mixtures of materials similar to those on the floor of a greenhouse. Thus, the radiation heat emitted by the resistor (6′) is attenuated by the aggregates contained in the tray (7), such that it prevents melting point being reached in any of the test specimens (3a, 3b). In addition, a fan is included in the chamber, so the temperatures in its interior are distributed evenly.

The tray (7) also contains the water needed for a certain level of humidity to be maintained inside the chamber (2). The water in the tray (7) is obtained from outside by way of a small pumping circuit, which is not shown in the figures.

The stress application means (8a, 8b) consist, in the example, of a set of weights attached to one end of the test specimen (3a, 3b). The size and number of the weights depend on the type of plastic, its thickness and the kind of test.

Besides these elements, the device (1) comprises a set of data acquisition means (10a, 10b, 11, 12, 13, 14, 15a) and a processing means (18), which is a PC in this example.

The data acquisition means (10a, 10b, 11, 12, 13, 14, 15a) of the device in the example are as follows:
Radiation sensors (10a, 10b), in this example photodiodes, which are used for the detection of the radiation emitted by radiation means (4a, 4b, 4c, 4d). The photodiodes provide a stress output proportional to the intensity in W/m²/nm emitted by the lamps. As mentioned above, the photodiodes are located at the same distance from the lamps as the test specimens.
Temperature probes (11, 12, 13, 14, 15a), which measure the temperature at different parts of the interior and exterior of the chamber. In this example it is a case of six Pt100 type temperature probes:
   Temperature probe (11): situated below the tray (7) of water so as to provide the lower temperature.
   Temperature probe (12): located inside the tray (7), which contains water and a heating resistor (6′).
   Temperature probe (13): situated at the top of the chamber (2), above the test specimens (3a, 3b).
   Temperature probe (14): on the outside of the chamber (2)
   Temperature probe (15a): it supplies the contact temperature of the additional piece (5a) on which the test specimen (3a) is supported. Although not shown in the figures, there is a second temperature probe which supplies the contact temperature of the additional piece (5b).

Besides this first set of data collection means (10a, 10b, 11, 12, 13, 14, 15a, 17), the device (1) of the example comprises:

Breakage detection means (9a, 9b), which in this example are microswitches that are activated when the set of weights falls on them, so that they automatically detect the breakage of the test specimens (3a, 3b). When this happens, a breakage signal is sent to the processing means (18), where it is stored and processed.

A conductive level sensor (16), which is used for detecting the water level in the tray (7). The level sensor (16) detects when the level exceeds a first upper level, so that a first high level LED is illuminated, and when it drops below a second lower level, so that a second low level LED is illuminated.

And a temperature/humidity sensor (17).

The data collected by all these data acquisition means are sent to the processing means (18) by way of a set of data acquisition modules (19). Although not specifically described in this example, the device (1) of the invention also comprises the electronic and data acquisition elements necessary for communication between the processing means (18) and said data acquisition means.

Finally, although preferred embodiments of the procedures and devices have been described, with reference to the environment in which they were developed, they are merely illustrative of the principles of the invention. Other embodiments and configurations could be devised without thereby diverging from the scope of the adjoining claims.

Furthermore, although the embodiments of the invention described with reference to the drawings may include computers and procedures executed in such machines, the invention also extends to the computer programs, particularly the computer programs that are situated on or in a carrier, tailored for the practical implementation of the invention. The program may take the form of a source code, object code, an intermediate code source and object code, for instance, such as in partly compiled form, or in any other form suitable for use in the implementation of the processes according to the invention. The carrier may be any entity or device capable of supporting the program.

For example, the carrier could include a means of storage, for instance, a ROM memory, a CD ROM memory or a semiconductor ROM memory, or a magnetic recording carrier, for example a diskette or hard disk. In addition, the carrier may be a transmissible carrier, for instance, an electrical or optical signal that could be conveyed by way of an electrical or optical cable, by radio or by any other means.

When the program is incorporated in a signal that may be transported directly by a cable or other device or means, the carrier may be composed of said cable or other device or means.

As a further version, the carrier could be an integrated circuit in which the program is included, while the integrated circuit is adapted either for executing or for being used in the execution of the corresponding processes.

1. A device for the simulation of the aging of polymeric materials, comprising:
a chamber that comprises at least one test specimen of polymeric material;
a means for radiating the test specimen of polymeric material;
a means for heating the interior of the chamber;
a means for applying mechanical stress to the test specimen of polymeric material;
a means for acquiring data on the external actions subjected upon the test specimen of polymeric material; and
a means for controlling the operation of the means of radiating, the means for heating, and the means for applying mechanical stress based on the acquired data.

2. The device of claim 1, wherein the means of radiating comprises radiation lamps, and wherein the radiation lamps' emission maximum lies in the UV-A, LJV-B, or Visible band.

3. The device of claim 2, wherein the radiation lamps emit an irradiance of up to 0.8 W/m².

4. The device of claim 1, wherein the means of heating comprises a blower fitted with resistors.

5. The device of claim 4, wherein the means of heating further comprises a resistor disposed in the chamber.

6. The device of claim 1, wherein the means of applying mechanical stress comprises weights fixed to one end of the test specimen of polymeric material.

7. The device of claim 1, wherein the means of acquiring data comprises acquisition comprise, at least, temperature sensors, radiation sensors, and stress sensors.

8. The device of claim 7, wherein the temperature sensors are Pt100 type thermocouples.

9. The device of claim 7, wherein the radiation sensors and the at least one test specimen are perpendicular to each other and equidistant from the means for radiating.

10. The device of claim 7, wherein the radiation sensors are photodiodes.

11. The device of claim 1, wherein the means for controlling of processing (18) comprise is selected from the group consisting of: one of the following a PC, a microprocessor, a microcontroller, a FPGA, a DSP, and an ASIC.

12. The device of claim 1, further comprising an additional piece that (5a, 5b) is in direct contact with the test specimen.

13. The device of claim 12, wherein the additional piece is a round section rod.

14. The device of claim 13, wherein the additional piece is made from a material selected from the group consisting of: iron, wood, steel, galvanized steel, and aluminium.

15. The device of claim 1, further comprising a means for applying humidity.

16. The device of claim 1, wherein the means for applying humidity comprises a humidity sensor.

17. The device of claim 1, further comprising a means for detecting breakage.

18. The device of claim 17, wherein the means for detecting of detection of breakage comprises is a microswitch (9a, 9b) are microswitches.

19. Device (1) for the simulation of the ageing of polymeric materials in accordance with The device of claim 1, wherein the at least one test specimen specimens (3a, 3b) of polymeric material is are plastic.

20. A method for simulating aging of polymeric materials, comprising the steps of:
(a) disposing at least one test specimen of polymeric material in the interior of a chamber;
(b) subjecting the test specimen of polymeric material simultaneously to the following conditions: a temperature of 20° C.-75° C.; a radiation of 290 nm-800 nm, with an irradiance of up to 0.8 W/m²; and a mechanical stress below the creep limit of the polymeric material; and
(c) observing the effect of the temperature, radiation, and stress on the aging of the test specimen.

21. The method of claim 20, wherein before step (b) the test specimen alternately undergoes a cycle of illumination and a cycle of darkness, wherein:
during the cycle of illumination, the temperature is 20° C.-75° C. and the radiation is 0.4-0.8 W/m²; and
during the cycle of darkness, the temperature is 20° C.-75° C. in the absence of radiation.

22. The method of claim 21, wherein the ratio of the duration of cycles of illumination to cycles of darkness is 6:1 to 10:1.

23. The method of claim 20, further comprising the step of detecting the time of breakage of the test specimen.

24. The method of claim 20, characterized in that it also further comprising comprises the step operation of subjecting the polymeric material test specimen to an external chemical aggression before the test specimen is disposed its introduction in the chamber.

25. A computer-readable medium encoding a software program configured to implement the method of claim 20.

26. The computer-readable medium of claim 25, wherein the software program is incorporated in storage device.

27. The computer-readable medium of claim 25, wherein the software program is supported on a carrier.
